(19) United States
(12) Patent Application Publication
(10) Pub. No.: US 2012/0200403 A1
(43) Pub. Date: Aug. 9, 2012

(54) METHODS, SYSTEMS, AND COMPUTER PROGRAM PRODUCTS FOR DIRECTING ATTENTION TO A SEQUENCE OF VIEWPORTS OF AN AUTOMOTIVE VEHICLE

(76) Inventor: Robert Paul Morris, Raleigh, NC (US)

(21) Appl. No.: 13/023,916

(22) Filed: Feb. 9, 2011

(51) Int. Cl. B60Q 1/00

(52) U.S. Cl. 340/438

(57) ABSTRACT

Methods and systems are described for directing attention to a sequence of viewports of an automotive vehicle. In one aspect, attention-sequence information is received that identifies a first viewport and a second viewport that provide, to an operator of an automotive vehicle, respective views of space external to the automotive vehicle. A sequence, that includes the first viewport preceding the second viewport, is identified based on the attention-sequence information. In response to identifying the sequence, first attention information is sent to present a first attention output, via an output device, for instructing the operator to attend to the first viewport. Second attention information is sent to present a second attention output, via an output device, for instructing the operator to attend to the second viewport subsequent to attending to the first viewport.

### RELATED APPLICATIONS

This application is related to the following commonly owned U.S. Patent Applications, the entire disclosures being incorporated by reference herein: application Ser. No. ______ (Docket No 0075) filed on 2011 Feb. 9, entitled “Methods, Systems, and Program Products for Directing Attention of an Occupant of an Automotive Vehicle to a Viewport”;

Application Ser. No. ______ (Docket No 0170) filed on 2011 Feb. 9, entitled “Methods, Systems, and Program Products for Altering Attention of an Automotive Vehicle Operator”; and

Application Ser. No. ______ (Docket No 0171) filed on 2011 Feb. 9, entitled “Methods, Systems, and Program Products for Managing Attention of an Operator of an Automotive Vehicle”.

### BACKGROUND

Driving while distracted is a significant cause of highway accidents. Recent attention to the dangers of driving while talking on a phone and/or driving while “texting” have brought the public's attention to this problem. While the awareness is newly heightened, the problem is quite old. Driving while eating, adjusting a car's audio system, and even talking to other passengers can and does take drivers' attention away from driving, thus creating and/or otherwise increasing risks.

While inattention to what is in front of a car while driving is clearly a risk, many drivers; even when not distracted by electronic devices, food, and other people; pay little attention to driving related information provided by mirrors, instrument panels, and more recently, cameras. Further, many drivers are not practiced or trained to shift their attention to views provided by windows, mirrors, and displays provided by an automotive vehicle.

Inattention may be a symptom of a sleepy driver and/or intoxicated driver. Raising the level of attention of such as driver may aid the driver. Directing the attention of a driver may be useful in heightening the driver's awareness of her/his impairment by demonstrating demands for the driver's attention.

A need exists to assist drivers in focusing their attention where it is needed to increase highway safety. Accordingly, there exists a need for methods, systems, and computer program products for directing attention to a sequence of viewports of an automotive vehicle.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for directing attention to a sequence of viewports of an automotive vehicle. In one aspect, the method includes receiving attention-sequence information identifying a first viewport and a second viewport that provide, to an operator of an automotive vehicle, respective views of space external to the automotive vehicle. The method further includes identifying, based on the attention-sequence information, a sequence that includes the first viewport preceding the second viewport. The method still further includes sending, in response to identifying the sequence, first attention information to present a first attention output, via an output device, for instructing the operator to attend to the first viewport. The method also includes sending second attention information to present a second attention output, via an output device, for instructing the operator to attend to the second viewport subsequent to attending to the first viewport.

Further, a system for directing attention to a sequence of viewports of an automotive vehicle is described. The system includes an attention policy component, a policy executive component, and an attention director component adapted for operation in an execution environment. The system includes the attention policy component configured for receiving attention-sequence information identifying a first viewport and a second viewport that provide, to an operator of an automotive vehicle, respective views of space external to the automotive vehicle. The system further includes the policy executive component configured for identifying, based on the attention-sequence information, a sequence that includes the first viewport preceding the second viewport. The system still further includes the attention director component configured for sending, in response to identifying the sequence, first attention information to present a first attention output, via an output device, for instructing the operator to attend to the first viewport. The attention director component is also configured for sending second attention information to present a second attention output, via an output device, for instructing the operator to attend to the second viewport subsequent to attending to the first viewport

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for directing attention to a sequence of viewports of an automotive vehicle according to an aspect of the subject matter described herein;

FIG. 3 is a block diagram illustrating an arrangement of components for directing attention to a sequence of viewports of an automotive vehicle according to another aspect of the subject matter described herein;

FIG. 4a is a block diagram illustrating an arrangement of components for directing attention to a sequence of viewports of an automotive vehicle according to another aspect of the subject matter described herein;

FIG. 4b is a block diagram illustrating an arrangement of components for directing attention to a sequence of viewports of an automotive vehicle according to another aspect of the subject matter described herein;

FIG. 5 is a diagram illustrating an exemplary system for directing attention to a sequence of viewports of an automotive vehicle according to another aspect of the subject matter described herein; and

FIG. 6 is a diagram illustrating a user interface presented to an occupant of an automotive vehicle in another aspect of the subject matter described herein

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

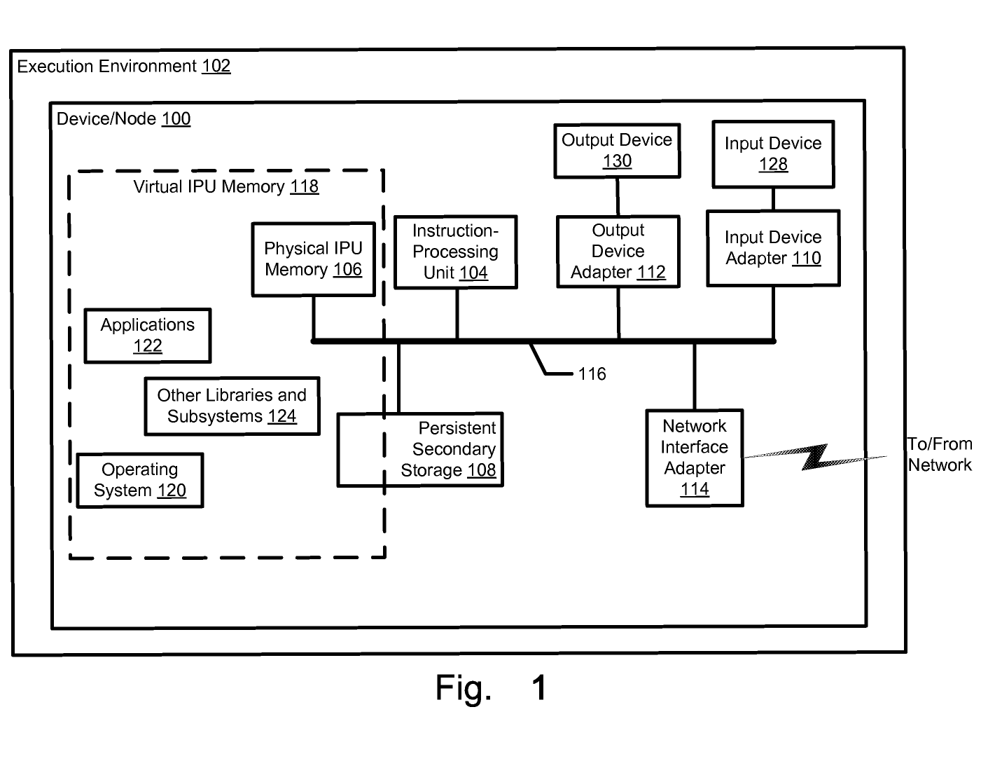

An exemplary device included in an execution environment that may be configured according to the subject matter is illustrated in FIG. 1. An execution environment includes an arrangement of hardware and, in some aspects, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in and/or otherwise providing suitable execution environments for configuring according to the subject matter include an automobile, a truck, a van, and/or sports utility vehicle. Alternatively or additionally a suitable execution environment may include and/or may be included in a personal computer, a notebook computer, a tablet computer, a server, a portable electronic device, a handheld electronic device, a mobile device, a multiprocessor device, a distributed system, a consumer electronic device, a router, a communication server, and/or any other suitable device. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical IPU memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display and/or an audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be identified by an operand of a machine code instruction and/or may be identified by a register or other portion of IPU 104.

FIG. 1 illustrates virtual IPU memory 118 spanning at least part of physical IPU memory 106 and at least part of persistent secondary storage 108. Virtual memory addresses in a memory address space may be mapped to physical memory addresses identifying locations in physical IPU memory 106. An address space for identifying locations in a virtual processor memory is referred to as a virtual memory address space; its addresses are referred to as virtual memory addresses; and its IPU memory is referred to as a virtual IPU memory or virtual memory. The terms “IPU memory” and “processor memory” are used interchangeably herein. Processor memory may refer to physical processor memory, such as IPU memory 106, and/or may refer to virtual processor memory, such as virtual IPU memory 118, depending on the context in which the term is used.

Physical IPU memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical IPU memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable medium. The drives and their associated computer-readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical IPU memory 106, and/or other components included in execution environment 102.

Output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a software component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of user interface elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

An order of visual outputs in a depth dimension is herein referred to as a “Z-order”. The term “Z-value” as used herein refers to a location in a Z-order. A Z-order specifies the front-to-back ordering of visual outputs in a presentation space. A visual output with a higher Z-value than another visual output may be defined to be on top of or closer to the front than the other visual output, in one aspect.

A “user interface (UI) element handler” component, as the term is used in this document, includes a component configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user-detectable representation of the program entity by an output device is referred to herein as “presentation information”. Presentation information may include and/or may otherwise identify data in one or more formats. Exemplary formats include image formats such as JPEG, video formats such as MP4, markup language data such as hypertext markup language (HTML) and other XML-based markup, a bit map, and/or instructions such as those defined by various script languages, byte code, and/or machine code. For example, a web page received by a browser from a remote application provider may include HTML, ECMAScript, and/or byte code for presenting one or more user interface elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the term “program” or “executable” refers to any data representation that may be translated into a set of machine code instructions and optionally associated program data. Thus, a program or executable may include an application, a shared or non-shared library, and/or a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program, specifiable in programming language in source code. An addressable entity is addressable in a program component translated for a compatible execution environment from the source code. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate languages for processing by an interpreter, compiler, linker, loader, and/or other analogous tool.

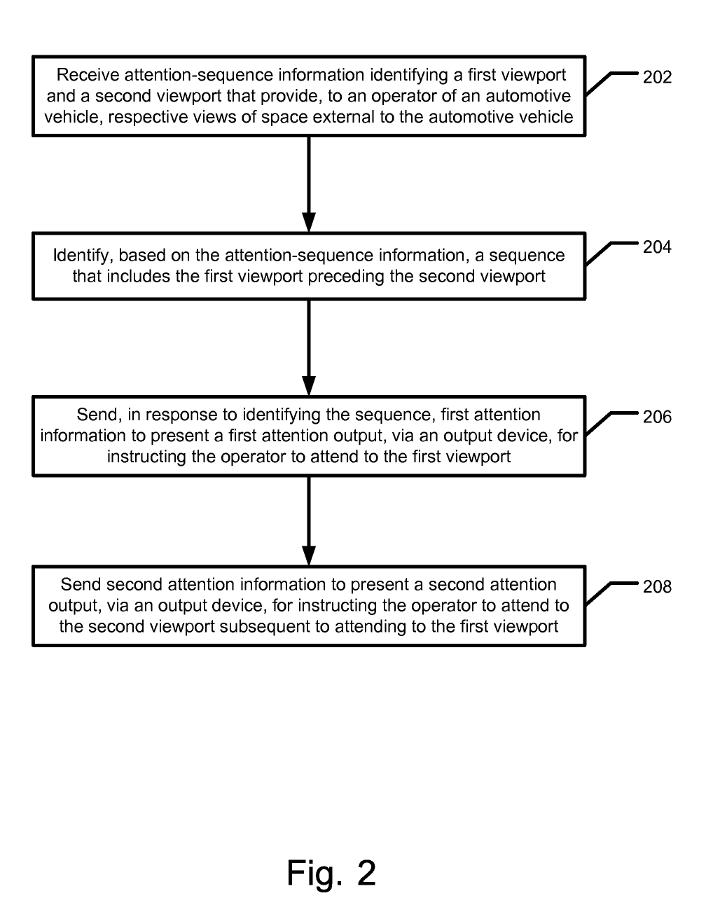

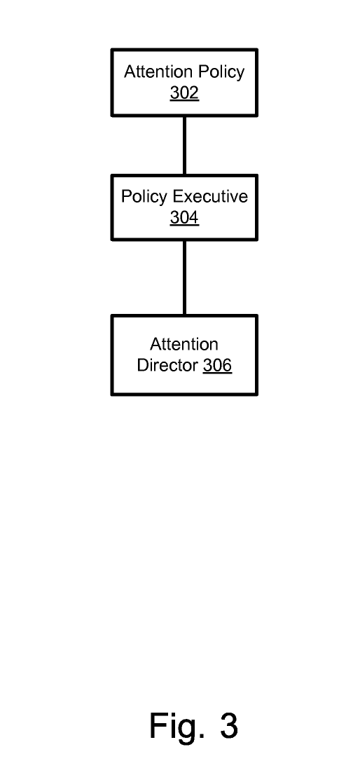

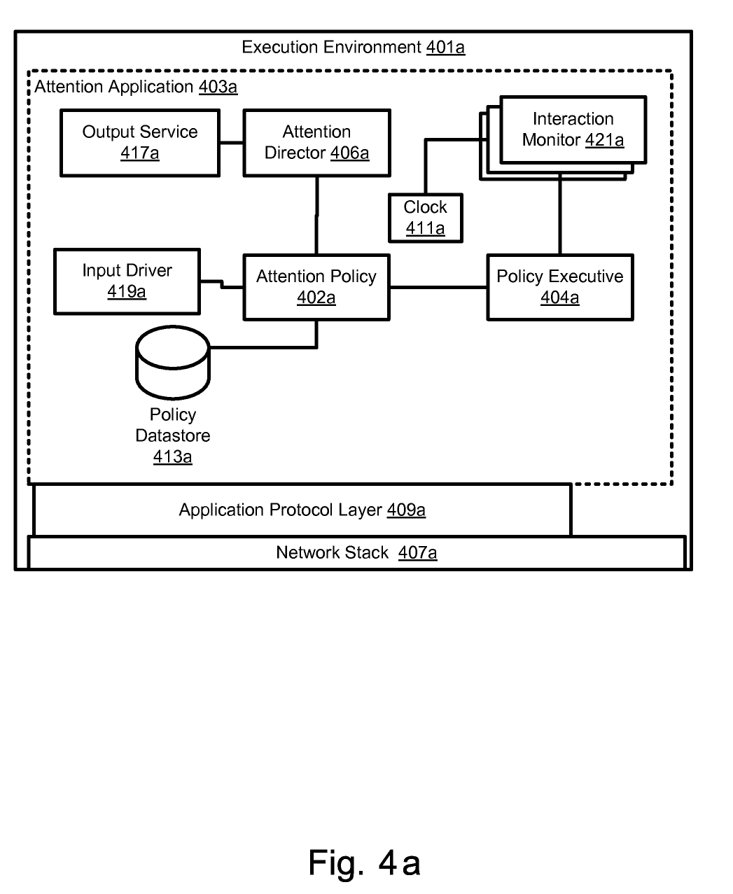

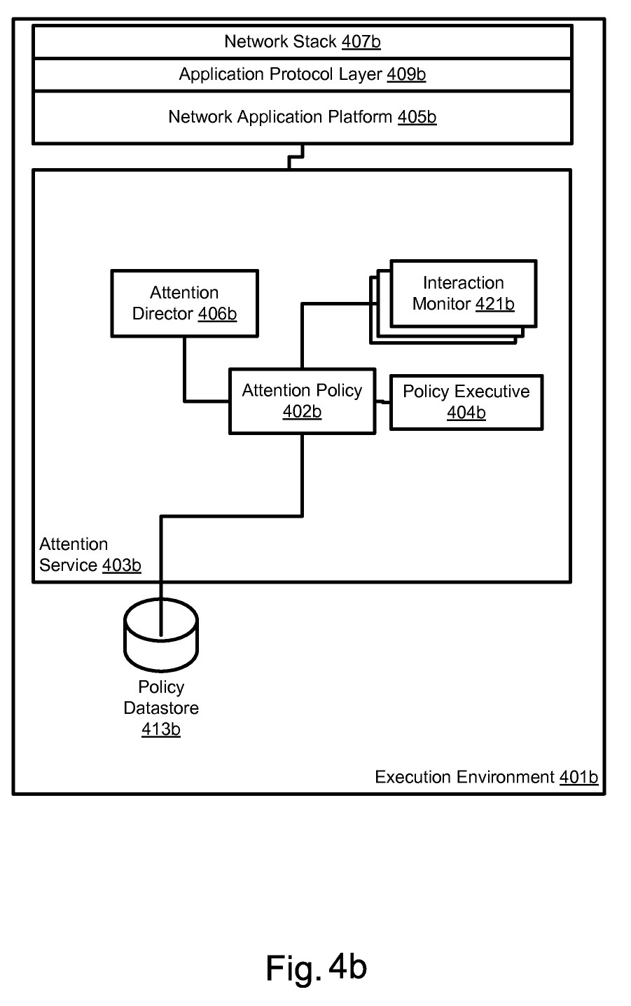

The block diagram in FIG. 3 illustrates an exemplary system for directing attention to a sequence of viewports of an automotive vehicle according to the method illustrated in FIG. 2. FIG. 3 illustrates a system, adapted for operation in an execution environment, such as execution environment 102 in FIG. 1, for performing the method illustrated in FIG. 2. The system illustrated includes an attention policy component 302, a policy executive component 304, and an attention director component 306. The execution environment includes an instruction-processing unit, such as IPU 104, for processing an instruction in at least one of the attention policy component 302, the policy executive component 304, and the attention director component 306. Some or all of the exemplary components illustrated in FIG. 3 may be adapted for performing the method illustrated in FIG. 2 in a number of execution environments. FIGS. 4a-b are each block diagrams illustrating the components of FIG. 3 and/or analogs of the components of FIG. 3 respectively adapted for operation in execution environments 401 that include and/or or that otherwise are provided by one or more nodes. Components, illustrated in FIG. 4a and FIG. 4b, are identified by numbers with an alphabetic character postfix. Execution environments; such as execution environment 401a, execution environment 401b, and their adaptations and analogs; are referred to herein generically as execution environment 401 or execution environments 401 when describing more than one. Other components identified with an alphabetic postfix may be referred to generically or as a group in a similar manner.

FIG. 1 illustrates key components of an exemplary device that may at least partially provide and/or otherwise be included in an execution environment. The components illustrated in FIG. 4a and FIG. 4b may be included in or otherwise combined with the components of FIG. 1 to create a variety of arrangements of components according to the subject matter described herein.

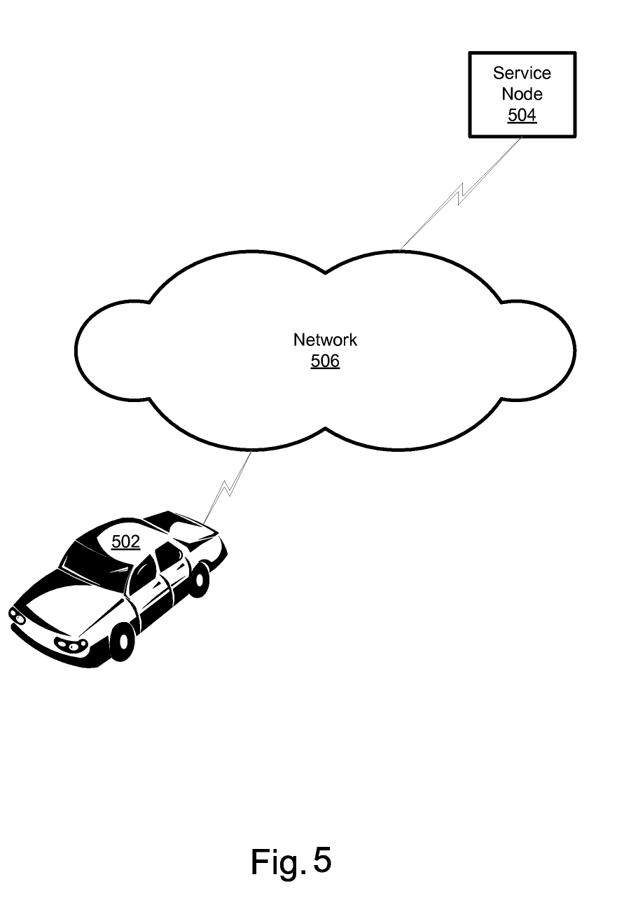

In an aspect, execution environment 401a may be included in an automotive vehicle. In FIG. 5, automotive vehicle 502 may include and/or otherwise provide an instance of execution environment 401a or an analog. FIG. 4b illustrates execution environment 401b configured to host a network accessible application illustrated by attention service 403b. Attention service 403b includes another adaptation or analog of the arrangement of components in FIG. 3. In an aspect, execution environment 401b may include and/or otherwise be provided by service node 504 illustrated in FIG. 5.

Adaptations and/or analogs of the components illustrated in FIG. 3 may be installed persistently in an execution environment while other adaptations and analogs may be retrieved and/or otherwise received as needed via a network. In an aspect, some or all of the arrangement of components operating in an execution environment of automotive vehicle 502 may be received via network 506. For example, service node 504 may provide some or all of the components.

An arrangement of components for performing the method illustrated in FIG. 2 may operate in a particular execution environment, in one aspect, and may be distributed across more than one execution environment, in another aspect. Various adaptations of the arrangement in FIG. 3 may operate at least partially in an execution environment in automotive vehicle 502 and/or at least partially in the execution environment in service node 504.

As described above, FIG. 5 illustrates automotive vehicle 502. An automotive vehicle may include a gas powered, oil powered, bio-fuel powered, solar powered, hydrogen powered, and/or electricity powered car, truck, van, bus, or the like. In an aspect, automotive vehicle 502 may communicate with one or more application providers, also referred to as service providers, via a network, illustrated by network 506 in FIG. 5. Service node 504 illustrates one such application provider. Automotive vehicle 502 may communicate with network application platform 405b in FIG. 4b operating in execution environment 401b included in and/or otherwise provided by service node 504 in FIG. 5. Automotive vehicle 502 and service node 504 may each include a network interface component operatively coupling each respective node to network 506.

FIGS. 4a-b illustrate network stacks 407 configured for sending and receiving data over network 506. Network application platform 405b in FIG. 4b may provide one or more services to attention service 403b. For example, network application platform 405b may include and/or otherwise provide web server functionally on behalf of attention service 403b. FIG. 4b also illustrates network application platform 405b configured for interoperating with network stack 407b providing network services for attention service 403b. Network stack 407a in FIG. 4a serves a role analogous to network stack 407b operating in various adaptations of execution environment 401b.

Network stack 407a and network stack 407b may support the same protocol suite, such as TCP/IP, or may communicate via a network gateway (not shown) or other protocol translation device (not shown) and/or service (not shown). For example, automotive vehicle 502 and service node 504 in FIG. 5 may interoperate via their respective network stacks: network stack 407a in FIG. 4a and network stack 407b in FIG. 4b.

FIG. 4a illustrates attention application 403a; and FIG. 4b illustrates attention service 403b, respectively, which may communicate via one or more application protocols. FIGS. 4a-b illustrate application protocol components 409 configured to communicate via one or more specified application protocols. Exemplary application protocols include a hypertext transfer protocol (HTTP), a remote procedure call protocol (RPC), an instant messaging protocol, and a presence protocol. Application protocol components 409 in FIGS. 4a-b may provide support for compatible application protocols. Matching protocols enable attention application 403a in automotive vehicle 502 to communicate with attention service 403b of service node 504 via network 506 in FIG. 5. Matching protocols are not required if communication is via a protocol gateway or other translator.

In FIG. 4a, attention application 403a may receive some or all of the arrangement of components in FIG. 4a in one more messages received via network 506 from another node. In an aspect, the one or more message(s) may be sent by attention service 403b via network application platform 405b, network stack 407b, a network interface component, and/or application protocol component 409b in execution environment 401b. Attention application 403a may interoperate via one or more of the application protocols provided by application protocol component 409a and/or via a protocol supported by network stack 407a to receive the message or messages including some or all of the components and/or their analogs adapted for operation in execution environment 401a.

An “interaction”, as the term is used herein, refers to any activity including a user and an object where the object is a source of sensory input detected by the user. In an interaction the user directs attention to the object. An interaction may also include the object as a target of input from the user. The input may be provided intentionally or unintentionally by the user. For example, a rock being held in the hand of a user is a target of input, both tactile and energy input, from the user. A portable electronic device is a type of object. In another example, a user looking at a portable electronic device is receiving sensory input from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user that is included in the interaction and presented by an output device that is included in the interaction.

As used herein “interaction information” refers to any information that identifies an interaction and/or otherwise provides data about an interaction between a user and an object. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

The term “occupant” as used herein refers to a passenger of an automotive vehicle. An operator of an automotive vehicle is an occupant of the automotive vehicle. As the terms are used herein, an “operator” of an automotive vehicle and a “driver” of an automotive vehicle are equivalent.

Interaction information for one viewport may include and/or otherwise identify interaction information for another viewport and/or other object. For example, a motion detector may detect an operator's head turn in the direction of a windshield of automotive vehicle 502 in FIG. 5. Interaction information identifying the operator's head is facing the windshield may be received and/or used as interaction information for the windshield indicating the operator's is receiving visual input from a viewport provided by some or all of the windshield. The interaction information may serve to indicate a lack of operator interaction with one or more other viewports such as a rear window of the automotive vehicle. Thus the interaction information may serve as interaction information for one or more viewports

The term “viewport” as used herein refers to any opening and/or surface of an automobile that provides a view of a space outside the automotive vehicle. A window, a screen of a display device, a projection from a projection device, and a mirror are all viewports and/or otherwise included in a viewport. A view provided by a viewport may include an object external to the automotive vehicle visible to the operator and/other occupant. The external object may be an external portion of the automotive vehicle or may be an object that is not part of the automotive vehicle.

With reference to FIG. 2, block 202 illustrates that the method includes receiving attention-sequence information identifying a first viewport and a second viewport that provide, to an operator of an automotive vehicle, respective views of space external to the automotive vehicle. Accordingly, a system for directing attention to a sequence of viewports of an automotive vehicle includes means for receiving attention-sequence information identifying a first viewport and a second viewport that provide, to an operator of an automotive vehicle, respective views of space external to the automotive vehicle. For example, as illustrated in FIG. 3, attention policy component 302 is configured for receiving attention-sequence information identifying a first viewport and a second viewport that provide, to an operator of an automotive vehicle, respective views of space external to the automotive vehicle. FIGS. 4a-b illustrate attention policy components 402 as adaptations and/or analogs of attention policy component 302 in FIG. 3. One or more attention policy components 402 operate in an execution environment 401.

In FIG. 4a, attention policy component 402a is illustrated as a component of attention application 403a. In FIG. 4b, attention policy component 402b is illustrated as a component of attention service 403b. Adaptations of attention policy component 302 in FIG. 3 may receive attention-sequence information from various sources in various aspects. Exemplary sources include a user, such as an operator of automotive vehicle 502, and/or another user such as a mechanic; a local and/or a remote data storage medium; and/or via a network from another node. Attention-sequence information may be received in response to various events in various aspects. For example, an attention policy component 402 may receive attention-sequence information in response to starting of automotive vehicle 502, in response to identifying an operator, in response to identifying a geospatial location of automotive vehicle 502, in response to a communication with a remote service provider via a network, in response to a user input, and/or in response to detecting access to a removable storage medium such as flash card.

Adaptations of attention policy component 302 in FIG. 3 may receive attention-sequence information via a variety of communication mechanisms in various aspects. Exemplary mechanisms for receiving attention-sequence information include an interprocess communications mechanism (IPC) such as a message queue, pipe, software interrupt, hardware interrupt, and/or a shared storage location; via an instruction directing a processor to access an attention policy component 402, such as a function, a subroutine, and/or a method invocation; and/or via a message transmitted via a network, such as a message from service node 504 via network 506.

FIG. 4a illustrates policy datastore 413a in attention application 403a. In an aspect, attention policy component 402a may retrieve attention-sequence information from policy datastore 413a when automotive vehicle 502 is operating. For example, a particular user may start automotive vehicle 502 using a key, a smart card, and/or an input such as personal identification number (PIN) that identifies the user as the current operator of automotive vehicle 502. The identification information may be received via an input driver for a keyed ignition switch, a smart card reader, and/or a keypad. An authentication component (not shown) may identify the user and provide the identity of the user to attention policy component 402a. Attention policy component 402a may access policy datastore 413a to locate and retrieve attention-sequence information based on the identified user.

In another aspect, attention policy component 402a may send a request to a remote service provider via network stack 407a and optionally application protocol layer 409a. The request may identify the user and/or automotive vehicle 502, to name two examples. In response, attention policy component 402a may receive attention-sequence information, based on the information identified in the request, in a response message received via network 506.

In still another aspect, attention policy component 402b in FIG. 4b may receive a message from automotive vehicle 502 and/or about automotive vehicle 502 from another source such as geo-location tracker. The message may identify a geospatial location of automotive vehicle 502 as well as other metadata such as velocity and direction. The message may be received by network application platform 405b as described above and routed to attention service 403b. Attention service 403b may provide the received information to attention policy component 402b. Attention policy component 402b may generate and/or retrieve attention-sequence information from policy datastore 413b based on the received information. Attention policy component 402b may then send a message to automotive vehicle 502 identifying the attention-sequence information. The message may be sent in response to a request from automotive vehicle 502 and/or may be sent in an asynchronous message with no corresponding request from automotive vehicle 502. For example, the asynchronous message may be sent at the direction of a geo-location service operating in another network node.

Alternatively or additionally, attention policy component 402b may retain attention-sequence information received for automotive vehicle 502 for processing the policy information in attention service 403b rather than and/or in addition to sending the attention-sequence information for processing by automotive vehicle 502.

Attention-sequence information may be received based on an attribute of the operator, an attribute of an occupant of the automotive vehicle other than the operator, an attribute of the automotive vehicle, and an attribute of an object external to the automotive vehicle visible to the operator in a viewport of the automotive vehicle, a temporal attribute, information from a sensor external to the automotive vehicle, and/or information from a sensor included in the automotive vehicle. An attribute of the operator may be based on a measure of age, a measure of operating experience, a preference configured for the operator, an ambient condition for the operator, a measure of operating time, an indicator of visual acuity, a measure of physical responsive, a disability, and/or an emotional state. Exemplary attributes of an automotive vehicle include a count of occupants in the automotive vehicle, a measure of velocity of the automotive vehicle, an object viewable to the operator via a viewport, a direction of movement, a location in the automotive vehicle of an occupant, an ambient condition, a geospatial location, a topographic attribute of a location including the automotive vehicle, and/or an attribute of a route of the automotive vehicle.

An attention policy component 402, in an aspect, may generate, retrieve, and/or otherwise receive attention-sequence information in response to detecting a change in one or more attributes, such as those described in the previous paragraph. Attention-sequence information may be received in response to a detected event including an ignition event, a change in velocity, a change in direction, a change in an ambient condition, a change in a measure of traffic, a change in a road surface, a change in geospatial location, and/or a change in time.

In another aspect, an operator or other user may select attention-sequence information and/or otherwise provide input specifying attention-sequence information. One or more representations of attention-sequence information may be presented via an output device via output service 417a in automotive vehicle 502. In another aspect, a representation may be presented in a device not included in automotive vehicle 502. A user input selecting a representation may be detected. An attention policy component 402 may receive attention-sequence information represented by the selected representation. For example, a user may select attention-sequence information via a notebook computer and/or a handheld electronic device. The selected attention-sequence information may be provided to automotive vehicle 502 via a network or communications link. The notebook computer, for example, may communicate with service node 504 to identify the selected attention-sequence information to automotive vehicle 502,

As illustrated in the previous paragraph, receiving attention-sequence information may include communicating with a portable electronic device that is in an automotive vehicle and that is not part of the automotive vehicle. Communications with the portable electronic device may be performed via a network interface card and/or a communications port as described with respect to FIG. 1. The portable electronic device may include a mobile phone, a media player, a media capture device, a notebook computer, a tablet computer, a netbook, a personal information manager, a media sharing device, an email client, a text messaging client, and/or a media messaging client. Communicating with a portable electronic device may include receiving attention-sequence information in response to an input detected by the portable electronic device. The input may identify interaction information for receiving and/or otherwise identifying attention-sequence information by an attention policy component 402.

Returning to FIG. 2, block 204 illustrates that the method further includes identifying, based on the attention-sequence information, a sequence that includes the first viewport preceding the second viewport. Accordingly, a system for directing attention to a sequence of viewports of an automotive vehicle includes means for identifying, based on the attention-sequence information, a sequence that includes the first viewport preceding the second viewport. For example, as illustrated in FIG. 3, policy executive component 304 is configured for identifying, based on the attention-sequence information, a sequence that includes the first viewport preceding the second viewport. FIGS. 4a-b illustrate policy executive components 404 as adaptations and/or analogs of policy executive component 304 in FIG. 3. One or more policy executive components 404 operate in execution environments 401.

In various aspects, adaptations of policy executive component 304 in FIG. 3 may determine a sequence of viewports according to attention-sequence information received by a corresponding adaptation of attention policy component 302. Attention-sequence information may include a specified sequence of viewports, in one aspect. In another aspect, attention-sequence information may include one or more instructions that when executed determine at least part of the sequence of viewports. In still another aspect, attention-sequence information may include declarative information; in for example, an extensible markup language (XML) based specification language; identifying one or more of the plurality of viewports and one or more conditions for determining at least part of a sequence of viewports. In yet another exemplary aspect, attention-sequence information may identify one more remote service providers that may be invoked to determine some or all of the viewports and/or some or all of the sequence.

In FIG. 4a, attention policy component 402a may be adapted to provide attention-sequence information in automotive vehicle 502 to policy executive component 404a. In an aspect, policy executive component 404a may identify a fixed or static sequence of viewports identified in and/or otherwise based on the attention-sequence information. In another aspect, policy executive component 404a may identify a next viewport in the sequence of viewports based on the attention-sequence information. Other information that may be included in identifying the next viewport includes the identity of a current viewport included in a detected interaction with the operator of automotive vehicle 502, another automotive vehicle within a specified distance and/or direction of automotive vehicle 502, the current time, and/or one or more current ambient conditions inside and/or outside automotive vehicle 502.

In another aspect, in FIG. 4b attention policy component 402b may provide attention-sequence information to policy executive component 404b in attention service 403b operating in service node 504. Policy executive component 404b may be adapted to determine and/or otherwise identify a sequence of viewports based on the attention-sequence information. Those skilled in the art will see that although operation of adaptations of policy executive 304 in execution environment 401a and in execution environment 401b may be similar, there will be operational differences relating to performance, reliability, and/or security to name a few operational attributes where differences and tradeoffs may exist.

In an aspect, identifying the sequence may include ordering and/or otherwise detecting an order for the viewports in the sequence. The order may be based on an attention criterion and/or a priority policy. For example, the order may be based on a pattern of interaction detected by one or more interaction monitor component 421a illustrated in FIG. 4a and/or interaction monitor components 421b illustrated in FIG. 4b. An interaction monitor component 421 may interoperate with an attention executive component 404, directly or indirectly, to provide interaction information. The attention executive component 404 may determine an order for viewports in a sequence based on the interaction information. Any information accessible to an attention director component in an execution environment that relates to the operator and/or automotive vehicle 502 operated by the operator may be suitable for determining an order. An attention executive component 404 may be configured to determine an order based on any such information accessible. In another aspect, the order may be specified in the attention-sequence information. For example, the order of viewports in a sequence may be predefined. The corresponding attention-sequence information may associate a number with each viewport that identifies the locations or order of the viewports in the sequence.

In another aspect, attention-sequence information may identify a viewport attribute for determining and/or otherwise detecting an order of viewports in a sequence. Determining a first viewport precedes a second viewport in a sequence may include ordering the viewports according to the identified viewport attribute. For example, an attention executive components 404 as illustrated respectively in FIGS. 4a-b may be configured to order viewports included in automotive vehicle 502 in a sequence based on one or more of a location of a viewport in the automotive vehicle, a measure of size of the viewport, a type of viewport, an attribute of motion of an object viewable via a viewport, a temporal attribute, an attribute of the operator, an ambient condition for the automotive vehicle, an attribute of an occupant of the automotive vehicle other than the operator, an ambient condition for the operator, an attribute of a geospatial location of the automotive vehicle, and/or a location in the automotive vehicle of an occupant.

Examples of operator attributes for determining an order of viewports include a measure of age, a measure of operating experience, a preference configured for the operator, a measure of operating time, an indicator of visual acuity, a measure of physical responsive, a disability, and an emotional state.

Examples of temporal attributes include a measure of time since interaction between a viewport and the automotive vehicle's operator has been detected, and a measure of time that a viewport has been included in one or more interactions with the operator within a specified time period. The attributes listed are exemplary and not exhaustive.

Exemplary attributes of an automotive vehicle include a count of occupants in the automotive vehicle, an attribute of the automotive vehicle, an attribute of a viewport, a velocity of the automotive vehicle, an object viewable to the operator via a viewport, a direction of movement of at least a portion of the operator, a start time, an end time, a length of time, a direction of movement of an automotive vehicle, an ambient condition in the automotive vehicle, an ambient condition for the automotive vehicle, a topographic attribute of a location including the automotive vehicle, an attribute of a route of the automotive vehicle, information from a sensor external to the automotive vehicle, and information from a sensor included in the automotive vehicle.

Returning to FIG. 2, block 206 illustrates that the method yet further includes sending, in response to identifying the sequence, first attention information to present a first attention output, via an output device, for instructing the operator to attend to the first viewport. Accordingly, a system for directing attention to a sequence of viewports of an automotive vehicle includes means for sending, in response to identifying the sequence, first attention information to present a first attention output, via an output device, for instructing the operator to attend to the first viewport.

Block 208, in FIG. 2, illustrates that the method additionally includes sending second attention information to present a second attention output, via an output device, for instructing the operator to attend to the second viewport subsequent to attending to the first viewport. Accordingly, a system for directing attention to a sequence of viewports of an automotive vehicle includes means for sending second attention information to present a second attention output, via an output device, for instructing the operator to attend to the second viewport subsequent to attending to the first viewport. For example, as illustrated in FIG. 3, attention director component 306 is configured for sending, in response to identifying the sequence, first attention information to present a first attention output, via an output device, for instructing the operator to attend to the first viewport. FIGS. 4a-b illustrate attention director components 406 as adaptations and/or analogs of attention director component 306 in FIG. 3. One or more attention director components 406 operate in execution environments 401.

The term “attention information” as used herein refers to information that identifies an attention output and/or that includes an indication to present an attention output. Attention information may identify and/or may include presentation information that includes a representation of an attention output, in one aspect. In another aspect, attention output may include a request and/or one or more instructions for processing by an IPU to present an attention output.

In various aspects, adaptations of attention director component 306 in FIG. 3 may send attention information for presenting a user-detectable output as an attention output to attract the attention of an operator and/or other occupant to a viewport via any suitable mechanism including an invocation mechanism, such as a function and/or method call utilizing a stack frame; an interprocess communication mechanism, such as a pipe, a semaphore, a shared data area, and/or a message queue; a register of a hardware component, such as an IPU register; a hardware bus, and/or a network communication, such as an HTTP request and/or an asynchronous message.

The term “attention output” as used herein refers to a user-detectable output to attract, instruct, and/or otherwise direct the attention of an operator and/or other occupant of an automotive vehicle to a viewport of the automotive vehicle. When an operator directs attention to a viewport, the operator and the viewport are included in an interaction, as the term has been defined herein.

In FIG. 4a, attention director component 406a may include a UI element handler component (not shown) for presenting a user-detectable attention output to attract, instruct, and/or otherwise direct attention from an operator and/or other occupant of automotive vehicle 502 to a viewport.

A UI element handler component in attention director component 406a may send attention information for presenting an attention output by invoking output service 417a to interoperate with an output device to present the attention output. Output service 417a may be operatively coupled to a display, a light, an audio device, a device that moves such as seat vibrator, a device that emits heat, a cooling device, a device that emits an electrical current, a device that emits an odor, and/or other output device that presents an output that may be sensed by an operator and/or other occupant. An attention output may be presented on and/or in a viewport in the sequence according to the order of the sequence. A next attention output may be presented to identify a viewport in the sequence as the next viewport for the operator to attend to, based on the order.

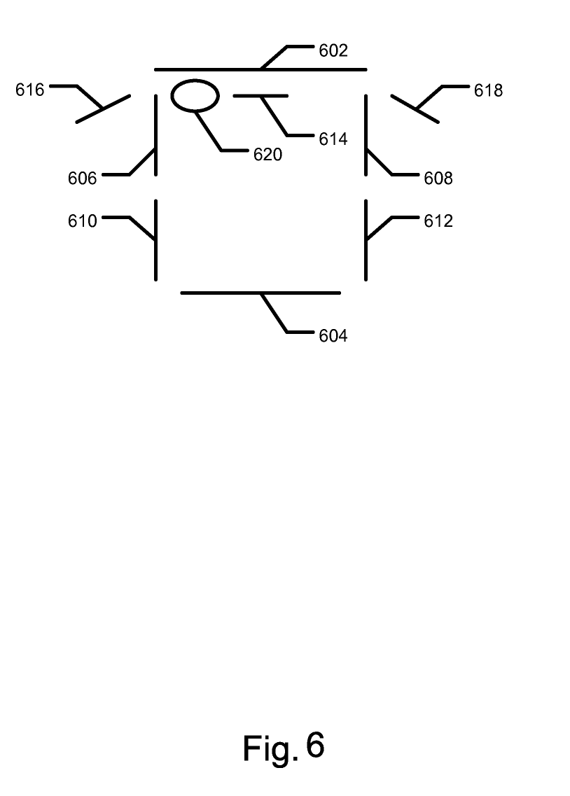

A user interface handler in attention director component 406a may invoke and/or communicate with a presentation device on and/or in a viewport to present an attention output to identify the viewport to direct an operator's attention to the viewport. A presentation device of automotive vehicle 502 may present representations of viewports at locations that identify the corresponding viewports in the sequence as illustrated in FIG. 6 described below. The attention director component 406a may interoperate with the presentation device to display an attention output in a location corresponding to a particular viewport to notify an operator that attention should be direct to the particular viewport. Thus a first attention output may be presented at the direction of attention director component 406a in a first location. A second attention output may be presented at a second location identifying a second viewport.

For example a first attention output may be presented in a heads-up display in a windshield to first direct the attention of the operator of automotive vehicle to a view provided by the windshield viewport. Subsequently, a second attention output may be presented via light on and/or in the direction of a left side-view mirror of automotive vehicle to direct the attention of the operator to a view in the left side-view mirror viewport.

In still another embodiment, attention director component 406b in FIG. 4b may receive attention-sequence information identifying a first viewport based on the first viewport's location in the sequence determined by policy executive 404b. Attention director component 406b may generate a message and/or request network application platform 405b to generate a message to send to automotive vehicle 502 to present a first attention output identifying the first viewport on a presentation device in automotive vehicle 502. The attention output may be presented on a display in a particular location that identifies the first viewport. In another aspect, an attention output may be presented on and/or in the first viewport. Alternatively, or additionally an attention output may be presented that identifies the first viewport independent of where the attention output is presented.

For example, the first viewport may be the windshield and the first attention output may be an audio indicator that plays “windshield” in a language of the operator. Attention director component 406b may send a message identifying audio data that when played by an audio output device plays “left side mirror” to present a second subsequent attention output based on the order of viewports in a sequence.

Visual, audio, and other user-detectable output may be presented to identify one or more viewports based on a correspondence between the attention output and a particular presentation device and/or a correspondence between a location of a presented attention output and a viewport. Visual, audio, and other user-detectable output may include an attention output that identifies a viewport independent of a particular output device and/or location of another attention output.

In addition to or instead of including a UI handler component, attention director component 406a may interoperate with a user interface handler component via output service 417a in order to present an attention output. An attention output may be represented by an attribute of a user interface element that represents a particular viewport. For example, attention director component 406a may send color information to present a color on a surface of automotive vehicle 502. The surface may include a viewport and/or may otherwise identify a viewport to an operator and/or other occupant. A color may be included in an attention output for a particular viewport. A first color may identify a location of a viewport in a sequence that is before the location of another viewport in the sequence as indicated by a second color. For example, red, orange, yellow, and green may respectively identify first, second, third, and fourth locations in the order of viewports in the sequence.

FIG. 6 illustrates user interface elements representing viewports to an operator and/or another occupant of an automotive vehicle. A number of viewports are represented in FIG. 6 by respective line segment user interface elements. The presentation in FIG. 6 may be presented on a display in a dashboard, on a sun visor, in a window, and/or on any suitable surface of an automotive vehicle. FIG. 6 illustrates front indicator 602 representing a viewport including a windshield of automotive vehicle 502, rear indicator 604 representing a viewport including a rear window, front-left indicator 606 representing a viewport including a corresponding window when closed or at least partially open, front-right indicator 608 representing a viewport including a front-right window, back-left indicator 610 representing a viewport including a back-left window, back-right indicator 612 representing a viewport including a back-right window, rear-view display indicator 614 representing a viewport including a rear-view mirror and/or a display device, left-side display indicator 616 representing a viewport including a left-side mirror and/or display device, right-side display indicator 618 representing a viewport including a right-side mirror and/or display device, and display indicator 620 representing a viewport including a display device in and/or on a surface of automotive vehicle 502. The user interface elements in FIG. 6 may be presented via the display device represented by display indicator 620 in the dashboard and/or as a heads up view presented in and/or on the front windshield.

Attention information representing an attention output for a viewport may include information for changing a border thickness in a border in a user interface element in and/or surrounding some or all of a viewport and/or a surface providing a viewport. For example, to attract attention to a view visible through the front-left mirror of automotive vehicle 502, attention director component 406a may send attention information to output service 417a to present front-left indicator 616 with a line thickness that is defined to indicate to an operator and/or other occupant to look at the left-side mirror or to look at the left-side mirror with more attentiveness. A line thickness may be an attention output and and/or a thickness relative to another attention output may identify an order of an attention output in a sequence of attention outputs respectively corresponding to viewports in a sequence of viewports.

A visual pattern may be presented in and/or on a surface providing a viewport. For example, attention director component 406b may send a message via network 506 to automotive vehicle 502. The message may include attention information instructing a presentation device to present rear-view indicator 614 with a flashing pattern and/or a pattern of changing colors, lengths, and/or shapes. Various patterns may identify various respective priorities or locations of viewports in a sequence of viewports.

In another aspect, a light in a mirror in automotive vehicle 502 and/or a sound emitted by an audio device in and/or on the mirror may be defined to correspond to a viewport including the mirror. The light may be turned on as directed by attention director component 406a to attract the attention of an operator and/or other occupant to the viewport and/or the sound may be output. The light may identify the viewport as a current viewport with respect to other viewports in the sequence without corresponding lights or other attention outputs.

Determining a sequence of viewports may include determining when to send attention information for one or more of the viewports in the sequence. That is, an attention executive component 404 may be configured to determine and/or otherwise identify timing information. In one aspect, a time for sending attention information to present an attention output may be identified by a measure of a time interval that is fixed or static. For example, attention executive component 406b may be configured to identify the number of seconds to wait before sending attention information for a second viewport after attention information has been sent for a first viewport. In another aspect, timing information may be determined dynamically. For instance, after sending first attention information to present a first attention output, attention director component 406a may interoperate with interaction monitor component 421a to determine whether an operator responded to the first attention output. Attention director component 406a may be configured to send the second attention output when a response from the operator is detected by interaction monitor component 421a. Timing may also be determined based on any of various attributes of an automotive vehicle and/or operator that have been described above in other uses.

In another aspect, attention information may be sent to end an attention output. For example, attention director component 406a may instruct output service component 417a to turn off an attention output represented by a light and/or end a sound that represents an attention output.

A user-detectable output to attract the attention of an operator and/or other occupant may provide relative interaction information as described above. In an aspect, attention director component 406b may send attention information to present attention outputs that are based on a multi-point scale providing relative indications of a need for an operator and/or other occupant's attention. Viewports may be associated with identifiers defined by the scale to indicate their order in a sequence. A viewport's location in a sequence may be identified with respect to other viewports based on the points on the scale associated with the respective viewports. A multipoint scale may be presented based on text such as a numeric indicator and/or may be graphical, based on a size or a length of the indicator corresponding to a priority ordering.

For example, a first attention output may present a number to an operator and/or other occupant for a first viewport and a second attention output may include a second number for a second viewport. A number may be presented to attract the attention of the operator and/or other occupant. The size of the numbers may indicate a location in a sequence of one viewport with respect to another. For example, if the first number is higher than the second number, the scale may be defined to indicate to the user that attention should be directed to the first viewport instead of and/or before directing attention to the second viewport.

A user interface element, including an attention output, may be presented by a library routine of output service 417a. Attention director component 406b may change a user-detectable attribute of the UI element. For example, attention director component 406b in service node 504 may send attention information via network 506 to automotive vehicle 502 for presenting via an output device of automotive vehicle 502. An attention output may include information for presenting a new user interface element and/or to change an attribute of an existing user interface element to attract the attention of an operator and/or other occupant.

A region of a surface in automotive vehicle 502 may be designated for presenting an attention output. As described above a region of a surface of automotive vehicle 502 may include a screen of a display device for presenting the user interface elements illustrated in FIG. 6. A position on and/or in a surface of automotive vehicle 502 may be defined for presenting an attention output for a particular viewport provided by the surface or to a viewport otherwise identified by and/or with the position. In FIG. 6, each user interface element representing a viewport has a position relative to the other user interface elements representing other respective viewports. The relative positions identify the viewports. A portion of a screen in a display device may be configured for presenting one or more attention outputs.

An attention director component 406 in FIG. 4a and/or in FIG. 4b may provide an attention output that indicates how soon a viewport requires attention of an operator and/or other occupant. For example, changes in size, location, and/or color may indicate whether a viewport requires attention and may give an indication of how soon a viewport may need attention and/or may indicate a level of attention suggested and/or required. A time indication for attention may give an actual time and/or a relative indication may be presented.

In FIG. 4b, attention director component 406b in attention service 403b may send information via a response to a request and/or via an asynchronous message to a client, such as attention application 403a and/or may exchange data with one or more input and/or output devices in automotive vehicle 502 directly and/or indirectly to receive interaction information and/or to present an attention output for a viewport provided by automotive vehicle 502.

A viewport may be visible via a surface of an automotive vehicle and attention information may be sent to direct the attention of the operator and/or of another occupant to the surface. Attention director component 406b may send attention information in a message via network 506 to automotive vehicle 502 for presenting by output service 417a via an output device. Output service 417a may be operatively coupled to a projection device for projecting a user interface element as and/or including an attention output on a windshield of automotive vehicle 502 to attract the attention of a driver to a particular viewport. An attention output may be included in and/or may include one or more of an audio interface element, a tactile interface element, a visual interface element, and an olfactory interface element.

Attention information may include time information identifying a duration for presenting an attention output to maintain the attention of an operator and/or other occupant. For example, a vehicle may be detected approaching automotive vehicle 502. Attention output may be presented by attention director component 406a in FIG. 4a for maintaining a driver's attention to a viewport including the approaching vehicle. The attention output may be presented for an entire duration of time that the vehicle is approaching automotive vehicle 502 or for a specified portion of the entire duration.

A user-detectable attribute and/or element of a presented output may be defined to identify a viewport to an operator and/or other occupant. For example, in FIG. 6 each line segment is defined to identify a particular viewport. A user-detectable attribute may include one or more of a location, a pattern, a color, a volume, a measure of brightness, and a duration of the presentation. A location may be one or more of in front of, in, and behind a surface of the automotive vehicle in which a viewport is visible. A location may be adjacent to a viewport and/or otherwise in a specified location relative to a corresponding viewport. An attention output may include a message including one or more of text data and voice data.

Attention information may include change information for presenting a change to a representation of one or more viewports to instruct the operator to attend to one or more of viewports. Presenting the attention output may include changing an attribute of a UI element representing a particular viewport. Exemplary attributes include a z-order, a level of transparency, a location in a presentation space, a size, a shape, a pattern, a color, a volume, brightness, and a time length of presentation.

In an aspect, the method may further include detecting a specified event subsequent to sending attention information; and sending attention information, in response to detecting the event. The specified event may include detecting an expiration of a timer, receiving acknowledgement information in response to a detected user input for responding to the first attention output, detecting that a viewport is no longer in the sequence, and/or detecting a change in the order of viewports in the sequence.

To the accomplishment of the foregoing and related ends, the descriptions herein and the referenced figures set forth certain illustrative aspects and/or implementations of the subject matter described. These are indicative of but a few of the various ways the subject matter may be employed. The other aspects, advantages, and novel features of the subject matter will become apparent from the detailed description included herein when considered in conjunction with the referenced figures.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable medium includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for directing attention to a sequence of viewports of an automotive vehicle, the method comprising:
receiving attention-sequence information identifying a first viewport and a second viewport that provide, to an operator of an automotive vehicle, respective views of space external to the automotive vehicle;
identifying, based on the attention-sequence information, a sequence that includes the first viewport preceding the second viewport;
sending, in response to identifying the sequence, first attention information to present a first attention output, via an output device, for instructing the operator to attend to the first viewport; and
sending second attention information to present a second attention output, via an output device, for instructing the operator to attend to the second viewport subsequent to attending to the first viewport.

2. The method of claim 1 wherein the first viewport includes at least a portion of at least one of a window, a display of an electronic display device, and a mirror; and wherein the second viewport includes at least a portion not included in the first viewport of at least one of a window, a display of an electronic display device, and a mirror

3. The method of claim 1 wherein the attention-sequence information is received in response to user input received from at least one of the operator and another occupant in the automotive vehicle, a message received via a network, a communication received from a portable electronic device, and an event detected by the automotive vehicle.

4. The method of claim 1 wherein the attention-sequence information is received based on at least one of an attribute of the operator, an attribute of an occupant of the automotive vehicle other than the operator, an attribute of the automotive vehicle, an attribute of an object external to the automotive vehicle visible to the operator in a viewport of the automotive vehicle, a temporal attribute, information from a sensor external to the automotive vehicle, and information from a sensor included in the automotive vehicle.

5. The method of claim 4 wherein the attribute of the operator is based on at least one of a measure of age, a measure of operating experience, a preference configured for the operator, an ambient condition for the operator, a measure of operating time, an indicator of visual acuity, a measure of physical responsive, a disability, and an emotional state.

6. The method of claim 4 wherein the attribute of the automotive vehicle includes at least one of a count of occupants in the automotive vehicle, a measure of velocity of the automotive vehicle, a direction of movement, a location in the automotive vehicle of an occupant, an ambient condition, a geospatial location, a topographic attribute of a location including the automotive vehicle, and an attribute of a route of the automotive vehicle.

7. The method of claim 1 wherein the attention-sequence information is received in response to a detected event based on at least one of ignition, a change in velocity, a change in direction, a change in an ambient condition, a change in a specified traffic condition, a change in a road surface, a change in geospatial location, and a change in time.

8. The method of claim 1 wherein receiving the attention-sequence information includes communicating with a portable electronic device in the automotive vehicle that is not part of the automotive vehicle.

9. The method of claim 8 wherein the portable electronic device includes at least one of a mobile phone, a media player, a media capture device, a notebook computer, a tablet computer, a netbook, a personal information manager, a media sharing device, an email client, a text messaging client, and a media messaging client.

10. The method of claim 8 wherein communicating with the portable electronic device includes receiving the attention-sequence information in response to an input detected by the portable electronic device

11. The method of claim 1 wherein the attention-sequence information identifies a viewport attribute and identifying the sequence includes ordering the viewports according to the identified viewport attribute.

12. The method of claim 1 wherein identifying the sequence includes determining when to send at least one of the first attention information and the second attention information.

13. The method of claim 1 wherein at least one of the first attention information and the second attention information includes change information for presenting a change to a representation of at least one of the first viewport and the second viewport to instruct the operator to attend to at least one of the first view and the second view.

14. The method of claim 1 wherein at least one of the first attention output is presented in a first location defined for identifying the first viewport and the second attention output is presented in a second location defined for identifying the second viewport.

15. The method of claim 14 wherein at least one of the first location identifies the first viewport based on the second location and the second location identifies the second viewport based on the first location.

16. The method of claim 1 further includes detecting a specified event subsequent to sending the first attention information; and sending the second attention information, in response to detecting the event.

17. The method of claim 16 wherein the specified event includes at least one of detecting an expiration of a timer, receiving acknowledgement information in response to a detected user input for responding to the first attention output, detecting that the first viewport is no longer in the sequence, and detecting a change in an order of viewports in the sequence.

18. The method of claim 1 wherein at least one of the first attention information and the second attention information includes timing information for determining a time for presenting the second attention output subsequent to presenting the first attention output.

19. A system for directing attention to a sequence of viewports of an automotive vehicle, the system comprising:
an attention policy component, a policy executive component, and a attention director component adapted for operation in an execution environment;
the attention policy component configured for receiving attention-sequence information identifying a first viewport and a second viewport that provide, to an operator of an automotive vehicle, respective views of space external to the automotive vehicle;
the policy executive component configured for identifying, based on the attention-sequence information, a sequence that includes the first viewport preceding the second viewport;
the attention director component configured for sending, in response to identifying the sequence, first attention information to present a first attention output, via an output device, for instructing the operator to attend to the first viewport; and
the attention director component configured for sending second attention information to present a second attention output, via an output device, for instructing the operator to attend to the second viewport subsequent to attending to the first viewport

20. A computer-readable medium embodying a computer program, executable by a machine, for directing attention to a sequence of viewports of an automotive vehicle, the computer program comprising executable instructions for:
receiving attention-sequence information identifying a first viewport and a second viewport that provide, to an operator of an automotive vehicle, respective views of space external to the automotive vehicle;
identifying, based on the attention-sequence information, a sequence that includes the first viewport preceding the second viewport;
sending, in response to identifying the sequence, first attention information to present a first attention output, via an output device, for instructing the operator to attend to the first viewport; and
sending second attention information to present a second attention output, via an output device, for instructing the operator to attend to the second viewport subsequent to attending to the first viewport
